(19) United States
(12) Patent Application Publication
(10) Pub. No.: US 2019/0207908 A1
(43) Pub. Date: Jul. 4, 2019

(54) ANONYMOUS MOBILE APP MESSAGING METHOD AND SYSTEM

(71) Applicant: Russell SCALISE, Chicago, IL (US)

(72) Inventor: Russell SCALISE, Chicago, IL (US)

(21) Appl. No.: 15/977,615

(22) Filed: May 11, 2018

Related U.S. Application Data
(60) Provisional application No. 62/611,127, filed on Dec. 28, 2017.

(51) Int. Cl. H04L 29/06; H04L 29/12; H04M 3/42; H04L 12/58; H04W 12/02

(52) U.S. Cl. CPC H04L 63/0421; H04L 61/2539; H04M 3/42008; H04L 51/32; H04W 12/02; H04L 2209/42; H04L 51/14

(57) ABSTRACT

Provided is a method and system for a sending individual to anonymously communicate information in real time or non-real time to another receiving individual, wherein both individuals are subscribers to a pre-selected group who have opted in to download and use an anonymous sending and receiving mobile app enabling said method and system, and wherein the receiving individual member of the group is the only receiver of the anonymous communication, and further wherein the communication is able to be sent and received as e-mail or text by wireless mobile device, Internet, virtual network, a communication network, social network, WAN and/or LAN.

### RELATED PRIORITY APPLICATION

This application claims priority to U.S. Provisional Patent Application Ser. No. 62/611,127, filed on Dec. 28, 2017.

### FIELD OF THE INVENTION

This invention is directed to a method and system for providing anonymous alerts of selective criteria of information from selective restricted groups of informers to an individual in real time or otherwise while maintaining confidentiality among group members.

### BACKGROUND OF THE INVENTION

Social media methods and systems have afforded the unique ability as of late to enable previously unobtainable real time and/or virtually concurrent reporting of an event to other interested parties.

For example, U.S. 20140188614A1 describes a mobile billboard messaging icon which displays messages related to a user's preferences from an advertiser on the display of a user's devices, such as Smartphone or tablet, having Internet connectivity, location technology, and logic means for determining when the user device is in a given vicinity of the advertiser's location. The coordinate location of the device is used to identify advertiser's locations within a pre-selected distance that correlate with user's preferences. Where a correlation is found, at least one message from the advertiser is displayed on the Smartphone or tablet device. The message is triggered when the device enters within the given radii from the advertiser. When triggered, the messaging icon provides relevant real-time promotions, deals and coupons for purchase of goods and services of the advertisers or sponsors related to the user preferences. The mobile billboard displays target messages based on both the user's specific preferences and the user's geographical real-time location.

In another example, U.S. Pat. No. 9,071,579 describes a method and system for a submitter to send and a receiver to receive, optionally in a one-click submission, various communications which can be, for example, time sensitive, mood related, secretive, medical, and/or threatening information, by means of at least one user interface of at least one input device, connected to, for example, the Internet, a virtual network, social network, world wide web, WAN, and/or LAN, to send anonymous/non-anonymous communications from the submitter which are encrypted through a secure connection/host system; have authorized persons receiving anonymous/non-anonymous communications from the submitter; and correlate/associate the anonymous/non-anonymous communications input by the submitter to aid in contacting appropriate receiving parties such as school officials, law enforcement, and/or health officials for sensitive information management of a student or other community member issues in reports or in taking other action.

Many, if not most, or even all such methods and systems, are very specific to their designed ends, but many, such as so-called anonymous methods and systems, including U.S. Pat. No. 9,071,579, cannot be readily counted on to provide reliable truthful information. For example, anyone can use a conventional anonymous information providing app to send disparaging and untruthful information relating to bullying or any other event of what may be considered misbehavior or other reprehensible act, for example, such as infidelity issues or perhaps theft. Anonymous “tweets” are infamously regularly used for such, and ubiquitously regarded with a great deal of mistrust and/or cause unnecessary disruption and discord, which is perhaps the intended purpose. Indeed, the Internet is well known for false defamation, infringing and negative information. On the other hand, truthful information on some websites and/or Tweets is readily removed for oftentimes purely political reasons. By allowing a plurality of users of unknown background for sending and receiving messages the problems associated with untruthfulness and non-veracity are exacerbated and compounded. There therefore exists an urgent need for reliable alternatives for information dissemination that can be trusted, at least initially.

This inventive method and system remedies such defective anonymous messaging to provide reliable information either in real time, or any time, which can be trusted and acted upon, all of which has been previously essentially unavailable. The invention is more fully illustrated and described below with reference to the example embodiment FIGs.

### SUMMARY OF THE INVENTION

The invention provides a readily reliable anonymous mobile app messaging method and system which is confined to a selected restricted group or groups to ensure trust and fidelity.

Accordingly, the invention is directed to method and system for a sending individual to anonymously communicate information in real time or non-real time to another receiving individual, wherein both individuals are subscribers to a pre-selected group who have opted in to download and use an anonymous sending and receiving mobile app, for example, comprising a unique algorithm enabling said method and system, and wherein the receiving individual member of the group is the only receiver of the anonymous communication, and further the communication is able to be sent and received as e-mail or text by wireless mobile device, Internet, virtual network, a communication network, social network, WAN and/or LAN.

The invention is more fully understood with reference to the following Detailed Description of preferred embodiments with reference to the FIGs.

### BRIEF DESCRIPTION OF THE DRAWINGS

FIG. 1 illustrates a schematic diagram of preferred embodiment according to the present invention.

FIG. 2 illustrates yet another schematic diagram of preferred embodiment according to the present invention.

FIG. 3 depicts an example schematic of establishing an informants networks.

FIGS. 4a, 4b, 4c and 4d depict further preferred embodiments of the invention.

FIG. 5 depicts a schematic of yet an additional preferred embodiment of the invention as to extended informants networks.

### DETAILED DESCRIPTION OF THE PREFERRED EMBODIMENTS

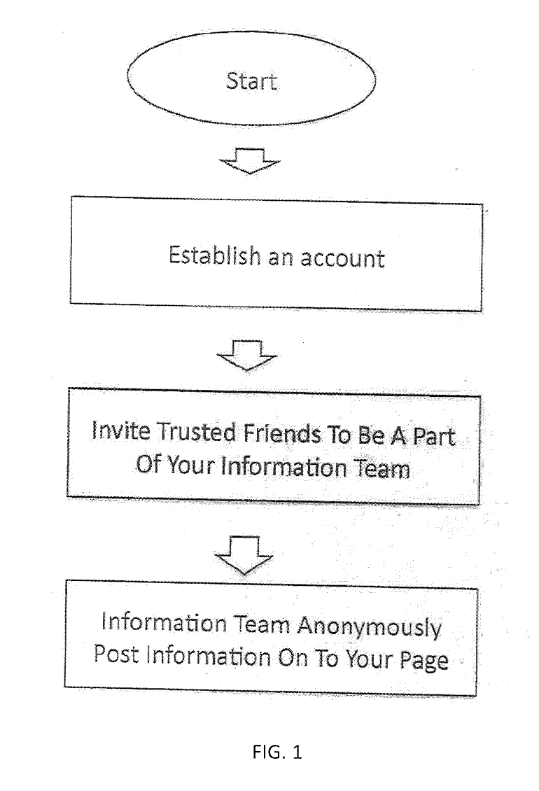

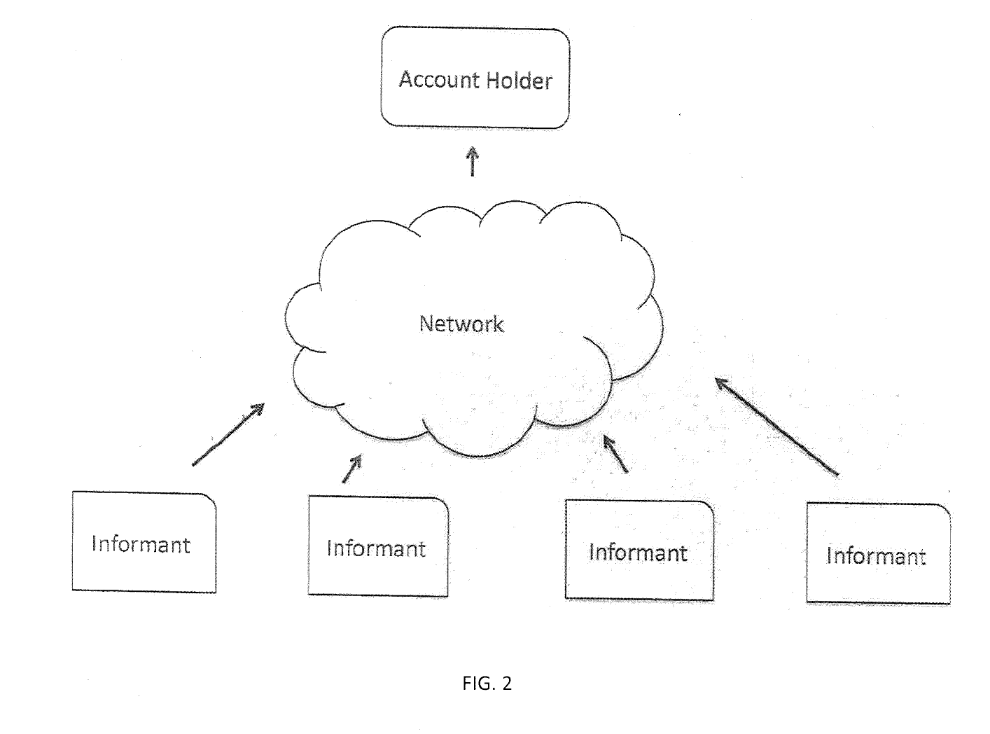

A preferred embodiment of the inventive method and system for the anonymous mobile app messaging method and system is shown in FIGS. 1 and 2. Here, there is provided a method and system for a sending individual to anonymously communicate pre-selected information in real time or non-real time to another receiving individual, wherein both individuals are the only individuals having access to the anonymous communication, and are both subscribers to a pre-selected group who have opted in to enable an anonymous sending and receiving app, after activating an icon on at least one of a computer, mobile device, smart phone device or tablet and the like, in which an opted in individual may, for example, optionally enter a login screen of the application in said method and system and in which the receiving individual member of the pre-selected group is the only receiver of the anonymous communication. The communication is contemplated to be sent by any conventional means, or non-conventional means developed in the future, such as, for example, a communication anonymously sent and received as e-mail or text message by wireless mobile devices, Internet, virtual network, any communication network, social network, WAN and/or LAN.

In its broadest sense, the invention described herein uniquely provides opted in users the opportunity to send anonymously to a single receiver or user, of a known and pre-selected group what is considered valuable information that members of the group have indicated a particular desire to receive, through, for example, a mobile application. The anonymously sent information in real time or non-real time incorporates a high degree of trustworthiness and veracity as it is sent and received one-on-one within a trusted and known network of friends or individuals. Users may acquire friends to be part of their network by invitation only and such an initial invitation from the user to the informant is non-anonymous, which means the users know which informants accepted the invitation. The users may determine and select via the inventive app what is considered valuable information, or any information, they desire to receive anonymously. Preferably, once a sending user has reached a predetermined, minimum quota of network friends, for example, five individuals who have opted in, communications between the parties would become anonymous by then. At this stage new individuals may be added as desired, for example opting in for a fee. Also, preferably, the method and system will not store data. For example, an individual receiver of an anonymous message may be permitted to respond to a message by a minimum number of queries, such as two and/or set for a timed limit of a week, after whichever event first occurs the message data is erased from both the sender's and receiver's data account. As mentioned, the method and system is contemplated to be accessible via PCs, similar to accessing for example, a Twitter, Facebook or Instagram account.

Preferred non-limiting example embodiments with reference to FIGS. 1 and 2 now follow to more fully describe and exemplify operation of the invention. With reference to FIG. 1 START 2, an account 4 is established by 6 inviting selected invitees, such as trusted individuals or friends, to be part of an initial information “team” to send and receive one-on-one/anonymous messages of pre-selected content 8.

In this preferred embodiment, an opted in user of the group may, for example, invite a minimum of five friends to serve as informants, of what may be referred to herein as “Birdies”. Also, within this preferred embodiment, the invited Birdies are at no time aware of each other's identities through the registration process or otherwise opting in use in downloading the enabling app. However, it is also contemplated in other embodiments that an initial user or former of the group may optionally inform invited Birdies of each other's existence, but which may prove less desirable for reasons such as confidentiality.

Once a predetermined minimum of invited Birdies has accepted, say five, an initial user's account will be activated. At this stage, the user knows which informants accepted the invitation. The number of invited Birdies is intentionally kept small to better insure manageability of truthfulness, accuracy and veracity in anonymous messaging.

In yet another aspect of this preferred embodiment, the initial user or former of the invited group of Birdies may determine in advance what information s/he desires to be alerted of. For example, as indicated in FIG. 2, the initial user may be the account holder 10 of the app inviting selected Birdies (informants) 12 to opt in by sending a text message with executable app comprising the opt in app icon, and thereafter, and anonymously receive information from one of the Birdies 12 via network 14 or a cloud (not shown) of the selected network of Birdies 12, to the exclusion of other Birdies 12, regarding an alert in real time or non-real time of a child's misbehavior or unauthorized conduct, and/or to receive, alerts of a cheating spouse, boyfriend or girlfriend, or to receive an alert of what may be considered unauthorized or reprehensible conduct in the workplace anonymously from a created network of Birdies at the workplace. A user may select what conduct, such as misbehaviors, they would like to be alerted of prior to inviting individuals or otherwise trusted friends to serve as Birdies.

Birdies may have a standard, predetermined alert option, such as, “Your Child Was Drinking”, or a predetermined maximum amount of words to convey the message such as, “Your Child Was Smoking Marijuana In The Park Last Night”. When a Birdy sends a message to a user, the message is anonymous to the user. Other Birdies in the user's network will not see the message, nor, will they even know that a message has been sent. Once a message has been sent the user will receive a notification informing them of the incoming message. The user will then have an option to ask the Birdy a question using a maximum of number of words, such as, “who was my child smoking marijuana with”? Preferably, the user will only be allowed to ask a maximum of, for example, two questions. Once the user asks their two questions or after a week has gone by, whichever comes first, the conversation is removed from the users and the Birdies account. At any time a user can add Birdies to her network of informants. Birdies will not be alerted of a user's desire to add more Birdies. Birdies will have the option of removing themselves from a user's network. When a Birdy opts out of a user's network the user will receive a notification alerting them that a Birdy has opted out. The user will know the identity of the Birdy who opted out. If at any time the user's number of Birdies dips below for example, the initially selected 5, the app will automatically suspend the user's account until the minimal amount of Birdies (5) is met. A user can create different networks of Birdies, such as, “neighborhood friends, school friends, travel sports friends”. Each network of Birdies operates independently of each other. If an existing Birdy would like to also have a network of Birdies they would have to create a different account and invite informants independently of the existing network they are already a part of. Informants can serve as Birdies in multiple networks.

Many other features are contemplated for use with invention, including optional use of sending anonymous encrypted information via employment of a specialized algorithm, such as disclosed in U.S. Pat. No. 9,071,579. Optional log-in may be accomplished by using a receiver unique identifier which may be verified by a host, or initial user inviter of Birdies, such as a host administration device, to verify intended recipients for enhanced security in communicating with intended recipients. Additionally, anonymous messages may have time stamps to indicate real time, or time lapse, and anonymous content specific conduct may be requested such as without limitation, drugs, bullying, infidelity, gambling, drinking or whatever can be imagined or contemplated.

As mentioned, the system may be accessible through a cloud which can be, for example, the Internet, a virtual network, social network, WAN, LAN or wireless cell system.

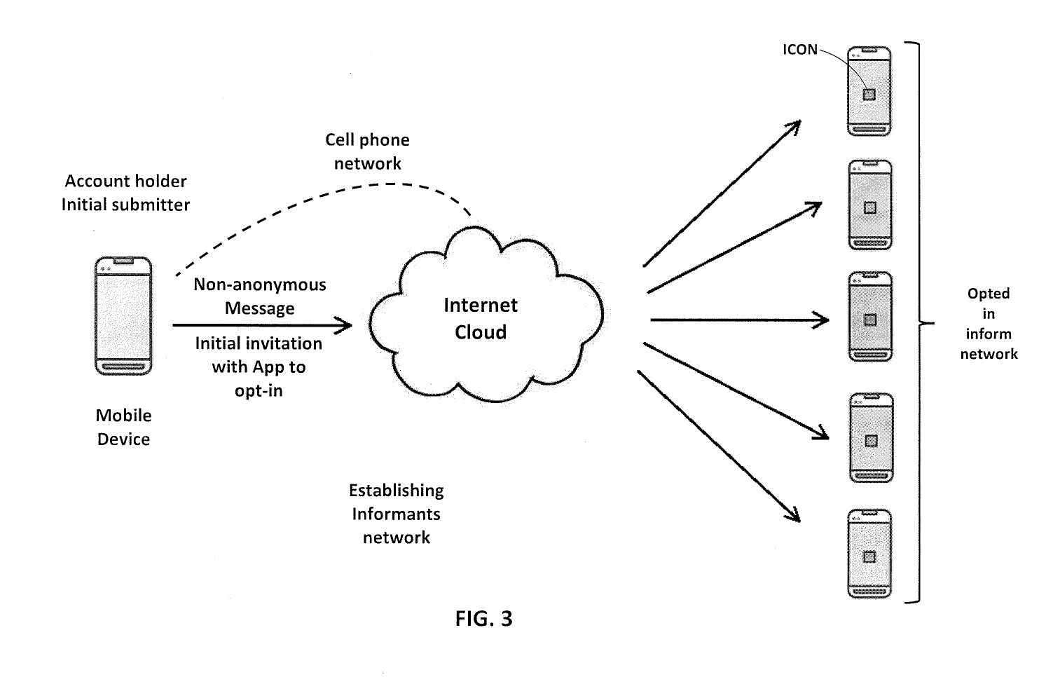

The invention is yet further illustrated with reference to the following FIGS. 3, 4a, 4b, 4c, 4d and 5.

Referring now to FIG. 3, there is exemplified a mobile to mobile messaging of an invitation to join in establishing an informants network. In this exemplified method and system, there is an example of messaging non-anonymous invitation inclusive of an executable app to opt in via established cell phone network or via a server through the Internet. As mentioned, the executable app may comprise a unique algorithm enabling said method and system.

By way of Internet connection through a server accessible by account holder/initial submitter 14 via network 16 (which may be internet, any virtual network, WAN and/or LAN), the server (not shown) which may be connected to a database identifying content, optionally enabling encryption, sends a message with executable app and invitation to opt in by executing an app and becoming an informant for Birdie. The opted in informants network 18 may comprise, for example, five informants, with all invitations and apps opted in to initialize the informant network. Any number of informants is contemplated but the informant group is preferably maintained as a small group to better insure trustworthiness, as described above and shown in FIG. 3.

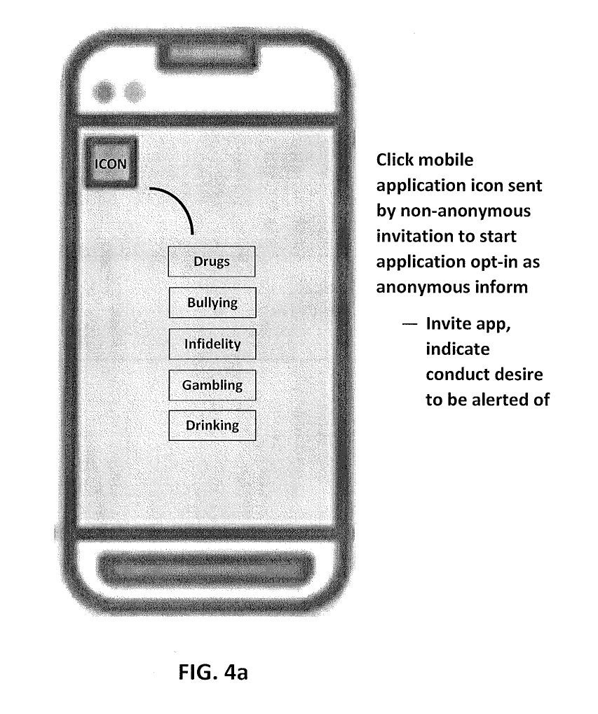

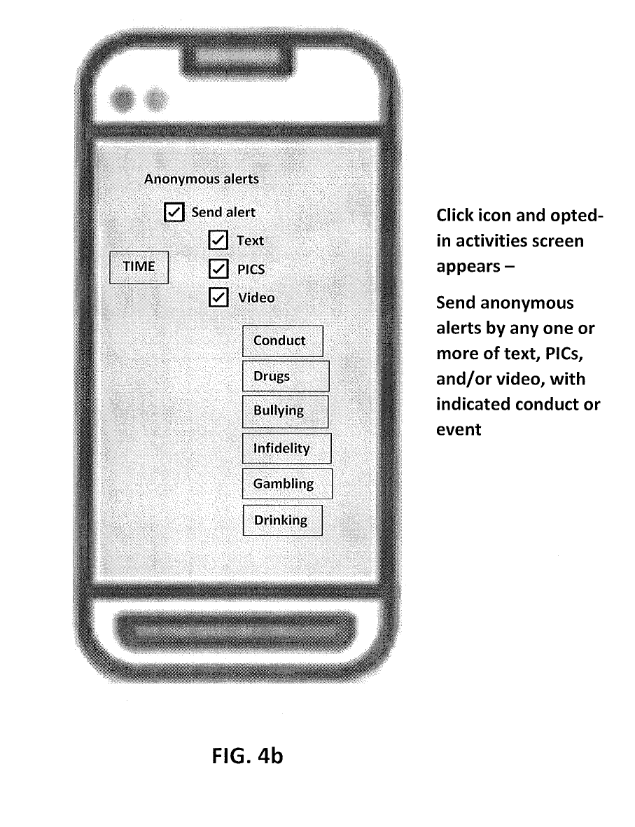

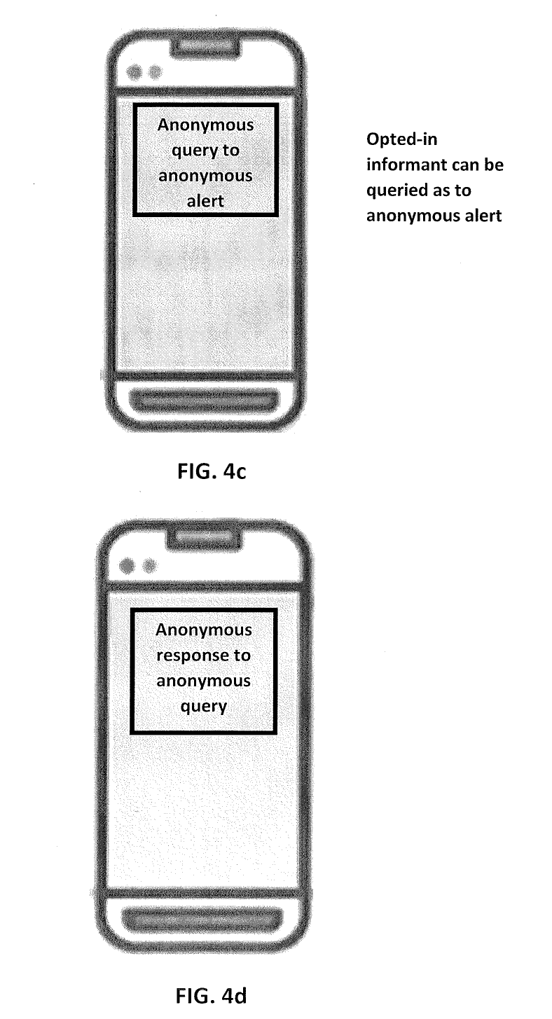

With reference to FIG. 4a, the messaged app to a chosen invitee informant displays an icon to click on to opt-in, and content desirous to be alerted of, such as, for example, without limitation, drug use, bullying, infidelity, gambling and/or drinking conduct. The conduct does not have to be what one may consider reprehensible or misbehavior, but simply what one wishes to be anonymously alerted of. Clicking on the icon will activate the app to the individual invitee informant, and the informants network system will then become operable when the contemplated number of invitee informants is reached, such as five, as discussed above and indicated.

As shown in FIG. 4b, preferably, upon clicking the icon and opting in, a screen display may be activated as to anonymous alerts, to send an anonymous alert via text, pictures, and/or video, with indicated conduct/content, and with a time stamp to indicate real time or otherwise.

FIG. 4c shows an example mobile screen display of an opted in informant receiving a query from the initial submitter 14 as to the sent anonymous alert, with FIG. 4d showing a response to the anonymous query.

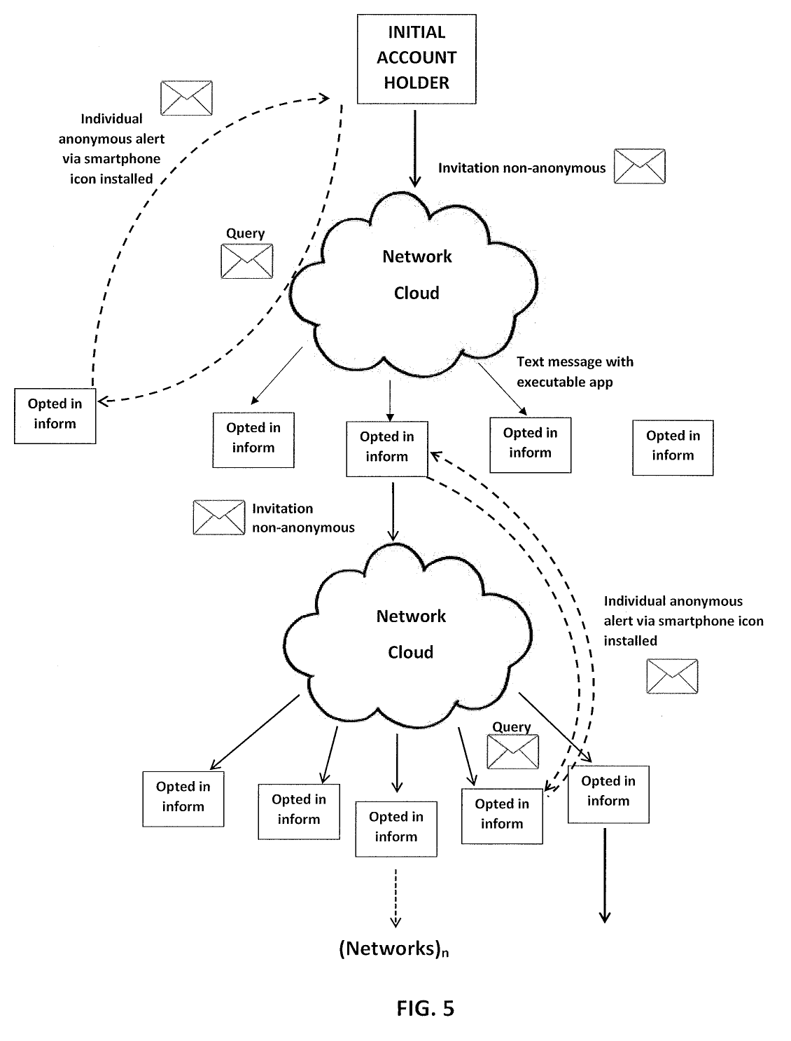

FIG. 5 shows an example of an extended opted in informants network, with initial account holder submitter sending non-anonymous invitations via server network (or which may be cell phone network, etc.) to a series of informants who have opted in, by clicking the app icon, and who have individually anonymously sent alerts and received an anonymous query (with query responses not shown). As also indicated, a one or more initially opted in informants may form a secondary informants network of their own, up to any number of informant networks.

Although preferred embodiments of the present invention have been described it will be understood by those skilled in the art that the invention is not limited to the described preferred embodiments. Rather, various changes and modifications may and/or can be made within the spirit and scope of the invention.

1. A method and system for a sending individual to anonymously communicate information in real time or non-real time to another receiving individual,
wherein both individuals are subscribers to a pre-selected group who have opted in to download and use an anonymous sending and receiving mobile app enabling said method and system, and
wherein the receiving individual member of the group is the only receiver of the anonymous communication, and further
wherein the communication is able to be sent and received as e-mail or text by wireless mobile device, Internet, virtual network, a communication network, social network, WAN and/or LAN.

2. The method and system of claim 1 wherein the content and length of the communication is pre-selected.

3. The method and system of claim 1 wherein said method and system is only operable when a selected number of subscribers have opted into the group after being invited to do so.

4. The method and system of claim 1 wherein said method and system allows users to receive information anonymously from a network of trusted informants.

5. The method and system of claim 1 wherein said users select trusted informants by invitation only through the system.

6. The method and system of claim 1 wherein the method and system is activated once a predetermined number of trusted informants have accepted the invitation.

7. The method and system of claim 1 wherein said method and system does not share the names of the trusted informants or the number of trusted friends the user has within their network.

8. The method and system of claim 1 wherein the method and system allows trusted informants to inform user of certain predetermined information anonymously.

9. The method and system of claim 1 wherein the method and system alerts user when a message has been received.

10. The method and system of claim 1 wherein the method and system alerts a trusted informant within the network, individually, when a message has been received.

11. The method and system of claim 1 wherein said method and system erases data after a predetermined time.

12. The method and system of claim 1 wherein the user can add to their network of confidants at any time.

13. The method and system of claim 12 wherein the confidants on the network are anonymous with each other.
